(19) United States
(12) Patent Application Publication
(10) Pub. No.: US 2015/0161001 A1
(43) Pub. Date: Jun. 11, 2015

(54) MISPROGRAMMING PREVENTION IN SOLID-STATE MEMORY

(71) Applicant: Western Digital Technologies, Inc., Irvine, CA (US)

(72) Inventor: ALDO G. COMETTI, SAN DIEGO, CA (US)

(73) Assignee: Western Digital Technologies, Inc., Irvine, CA (US)

(21) Appl. No.: 14/099,816

(22) Filed: Dec. 6, 2013

(51) Int. Cl. G06F 11/10

(52) U.S. Cl. CPC G06F 11/1068; G06F 11/1072

(57) ABSTRACT

Systems and methods for programming data in a non-volatile memory array are disclosed. Certain embodiments provide a controller configured to program a lower page of a plurality of memory cells of the non-volatile memory array. The controller may submit the programmed lower page to an error correction module and receive correction data relating to the lower page from the error correction module. The correction data is used to program an upper page of the plurality of memory cells in order to at least partially reduce upper page misprogramming events.

### BACKGROUND

1. Field

This disclosure relates to data storage systems. More particularly, the disclosure relates to systems and methods for programming solid-state memory.

2. Description of Related Art

Certain solid-state memory devices, such as flash drives, store information in an array of memory cells constructed with floating gate transistors. Misprogramming of data in a solid-state memory cell may adversely affect device performance.

### BRIEF DESCRIPTION OF THE DRAWINGS

[³] Various embodiments are depicted in the accompanying drawings for illustrative purposes, and should in no way be interpreted as limiting the scope of this disclosure. In addition, various features of different disclosed embodiments can be combined to form additional embodiments, which are part of this disclosure.

FIG. 1 is a block diagram of a data storage system including a non-volatile memory array according to an embodiment.

FIG. 2 is a graph showing a probability distribution of cells in a non-volatile memory array according to an embodiment.

FIGS. 3A-3C illustrate probability distributions of cells at various stages of a programming process according to an embodiment.

FIGS. 4A-4C illustrate probability distributions of cells at various stages of a programming process resulting in misprogramming according to an embodiment.

FIG. 5 is a flow diagram illustrating a process for programming data in a non-volatile memory array according to an embodiment.

FIG. 6 is a flow diagram illustrating a process for programming data in a non-volatile memory array using according to an embodiment.

FIG. 7 is a block diagram of a data storage system including lower page error correction according to an embodiment.

### DETAILED DESCRIPTION

While certain embodiments are described, these embodiments are presented by way of example only, and are not intended to limit the scope of protection. Indeed, the novel methods and systems described herein may be embodied in a variety of other forms. Furthermore, various omissions, substitutions and changes in the form of the methods and systems described herein may be made without departing from the scope of protection. The headings provided herein are for convenience only and do not necessarily affect the scope or meaning of the claimed invention.

### Terminology

As used in this application, “non-volatile solid-state memory,” “non-volatile memory,” “NVM,” or variations thereof may refer to solid-state memory such as NAND flash. However, the systems and methods of this disclosure may also be useful in more conventional hard drives and hybrid drives including both solid-state and hard drive components. Solid-state memory may comprise a wide variety of technologies, such as flash integrated circuits, Phase Change Memory (PC-RAM or PRAM), Programmable Metallization Cell RAM (PMC-RAM or PMCm), Ovonic Unified Memory (OUM), Resistance RAM (RRAM), NAND memory, NOR memory, EEPROM, Ferroelectric Memory (FeRAM), MRAM, or other discrete NVM (non-volatile solid-state memory) chips. The non-volatile solid-state memory arrays or storage devices may be physically divided into planes, blocks, pages, and sectors, as is known in the art. Other forms of storage (e.g., battery backed-up volatile DRAM or SRAM devices, magnetic disk drives, etc.) may additionally or alternatively be used.

The terms “page,” “target page,” or variations thereof are used herein according to their broad and ordinary meaning. For example, “page” may refer to a block of a physical memory cells, or to the physical memory cells themselves. Furthermore, within a multi-level cell (MLC), “page” may refer to either of upper or lower pages, which may in tern be associated with most significant bits (MSB), least significant bits (LSB), or other programming mechanism or scheme.

The terms “proto page,” “intermediate page,” “intermediate state,” “intermediate programming page,” “LSB proto page,” or variations/combinations thereof may refer to a voltage state or distribution corresponding to a partial programming of a cell, such as a lower page, or LSB, programming of a cell, wherein further programming of the cell(s) may be performed to program upper page, or MSB, data.

### Overview

The present disclosure provides systems and methods for programming solid-state memory devices, wherein data associated with memory cells programmed to an intermediate programming state (e.g., an LSB proto state) is subjected to error correction in order to reduce occurrences of upper page misprogramming. In MLC solid-state memory, such as MLC NAND flash, as program/erase (P/E) cycles increase, misprogramming errors may increasingly occur when programming MSB pages. Such misprogramming errors may be caused by, for example, distribution widening of cells in a lowest state (e.g., erased state) after LSB page programming.

Certain MLC programming schemes involve multi-stage programming, wherein a first page, such as a lower page corresponding to a least significant bit (LSB), is programmed first, followed by programming of a second page, such as an upper page corresponding to a most significant bit (MSB). When executing the MSB page programming, it may be necessary or desirable to read out the programmed LSB page values to determine the final value at which the cells are to be programmed to achieve the correct MSB distribution. With increased P/E cycles, the upper side of the programmed LSB page corresponding to a lower or erased state can overlap the read level used to distinguish lower page values, thereby resulting in level misprogramming. For example, where states in an MLC distribution are defined from lowest voltage to highest voltage as L0-L3, L0 may be misprogrammed to L3 and L1 to L2. In certain embodiments, misprogrammed cells may increase with increased P/E cycles, and may reach up to 10% of the total errors, or more.

Misprogrammed cells can increase Raw Bit Error Rate (RBER) values, thereby adversely affecting device performance. Furthermore, it may not be possible or trivial to correct misprogrammed cells with read level adjustment or through multi-read soft decision input generation, which can further worsen the ability to perform error correction. Certain embodiments disclosed herein provide systems and methods for reducing misprogramming occurrences by performing error correction on LSB page data before using LSB values to program MSB pages. Systems and methods disclosed herein may be applicable in any multi-level NVM memory, such as MLC, three-level cell (TLC), or other multi-level programming scheme.

### Data Storage System

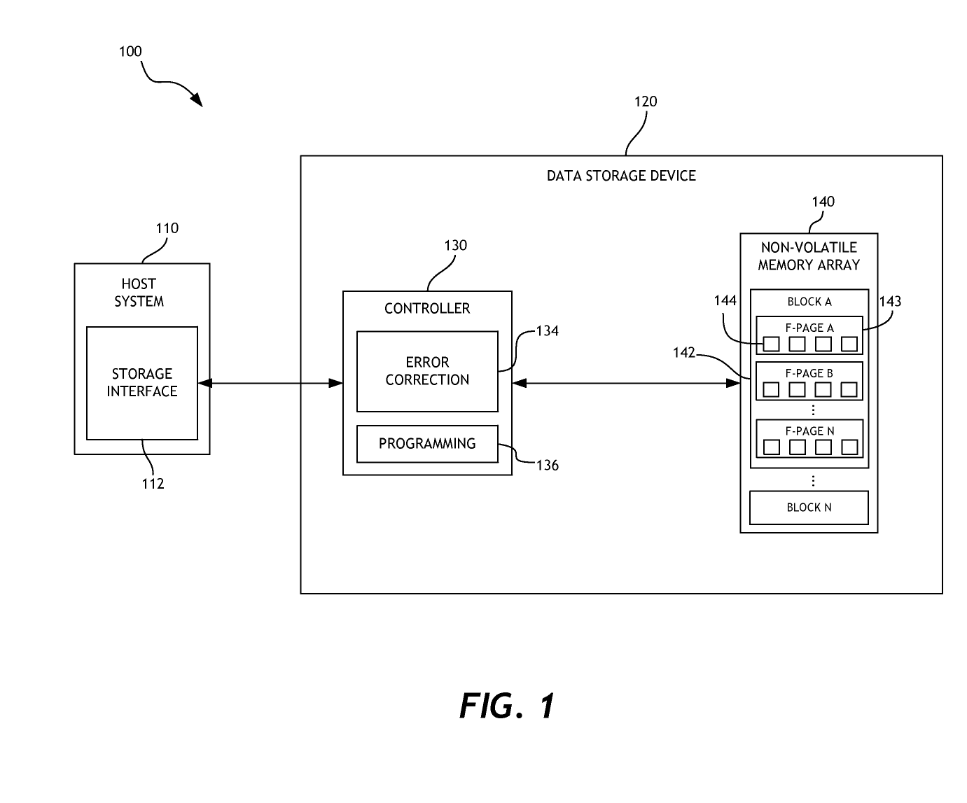

FIG. 1 is a block diagram illustrating an embodiment of a combination of a host system 110 with a data storage device 120 incorporating error correction functionality in accordance with embodiments disclosed herein. As shown, the data storage device 120 (e.g., hybrid hard drive, solid-state drive, any storage device utilizing solid-state memory, etc.) includes a controller 130 configured to receive data commands and execute such commands in a non-volatile solid-state memory array 140. Such commands may include data read/write commands, and the like. The controller 130 may be configured to receive data commands from a storage interface (e.g., a device driver) 112 residing on a host system 110. Data commands may specify a block address in the data storage device 120; data may be accessed/transferred based on such commands.

The data storage device 120 can store data received from the host system 110 such that the data storage device 120 acts as data storage for the host system 110. To facilitate this function, the controller 130 may implement a logical interface. The logical interface can present to the host system memory as a set of logical addresses (e.g., sequential/contiguous addresses) where data can be stored. Internally, the controller 130 can map logical addresses to various physical memory addresses in the non-volatile solid-state memory array 140 and/or other memory module(s). Mapping data indicating the mapping of logical addresses to physical memory addresses may be maintained in the data storage device. For example, mapping table data may be stored in non-volatile memory array(s) 140 in order to allow for recreation of mapping tables following a power cycle.

The controller 130 may include one or more memory modules (not shown), such as non-volatile memory (e.g., ROM) and/or volatile memory (e.g., RAM, such as DRAM). In certain embodiments, the controller 130 may be configured to store information, including, for example, operating system(s) code, application code, system tables and/or other data, in the non-volatile solid state memory array 140. On power-up, the controller 130 may be configured to load such data for use in operation of the data storage device.

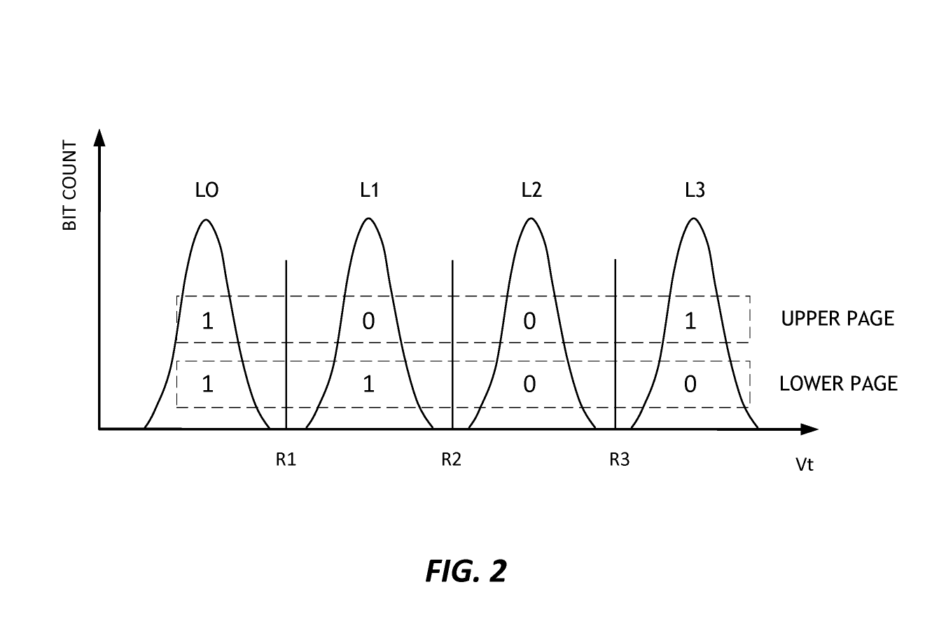

The controller 130 may receive memory access commands from the host system, including programming commands, and implement such programming commands in the non-volatile memory array using a programming module 136. For example, the programming module 136 may implement a desirable programming scheme suitable for the non-volatile memory array. In certain embodiments, the programming module 136 is configured to implement a MLC programming scheme in which cells of solid-state memory are programmed to store a charge level representative of two or more bits of data. Such a programming scheme is described in further detail below with reference to FIG. 2.

The controller 130 further includes an error correction (ECC) module 134 for controlling errors when decoding data read from the non-volatile memory array 140. The error correction module 134 may be configured to processes data read from the non-volatile memory array 140 including redundancy data and/or various quality metrics in order to increase the likelihood of accurately recovering the read data. The error correction module 134 may be configured to decode the read data using hard decoding and/or soft decoding. For example, the error correction module 134 may be configured to generate and/or receive soft-decision input, wherein the soft-decision input represents a probability that the detected data symbol was accurately detected. Such soft-decision data may include, for example, log likelihood ratio (LLR) values. The error correction module 134 may comprises a low-density parity-check (LDPC) decoder configured to correct data read from the non-volatile memory array based on LLR values.

FIG. 2 is a graph showing a probability distribution of cells in a non-volatile memory array according to an embodiment. The distribution of FIG. 2 is associated with an MLC programming scheme, in which two bits of information are stored in a single memory cell. However, it should be understood that systems and methods disclosed herein may be utilized with respect to single-level cell (SLC) technology, or other technologies.

FIG. 2 shows four programming states (L0-L3), wherein each state represents two bits of data. In certain embodiments, the programming states each comprise a most-significant bit, referred to herein as the “upper page,” and a least-significant bit, referred to herein as the “lower page.” Furthermore, in certain embodiments, “upper page” may refer to the least-significant bit, while “lower page” refers to the most-significant bit. While particular coding values are assigned to the various states of the distribution (e.g., ‘11’ for L0, ‘01’ for L1, ‘00’ for L2, and ‘10’ for L3), other coding schemes may be used. In certain embodiments, L0 corresponds to an erased state.

In decoding memory cells, one or more reference voltage levels may be used to read the cells to determine what charge state the cells belong to. FIG. 2 illustrates three voltage read levels, R1, R2 and R3. In certain embodiments, lower page values may be determined based on a read at R2, while upper page values may be obtained by reading at R1 and/or R3.

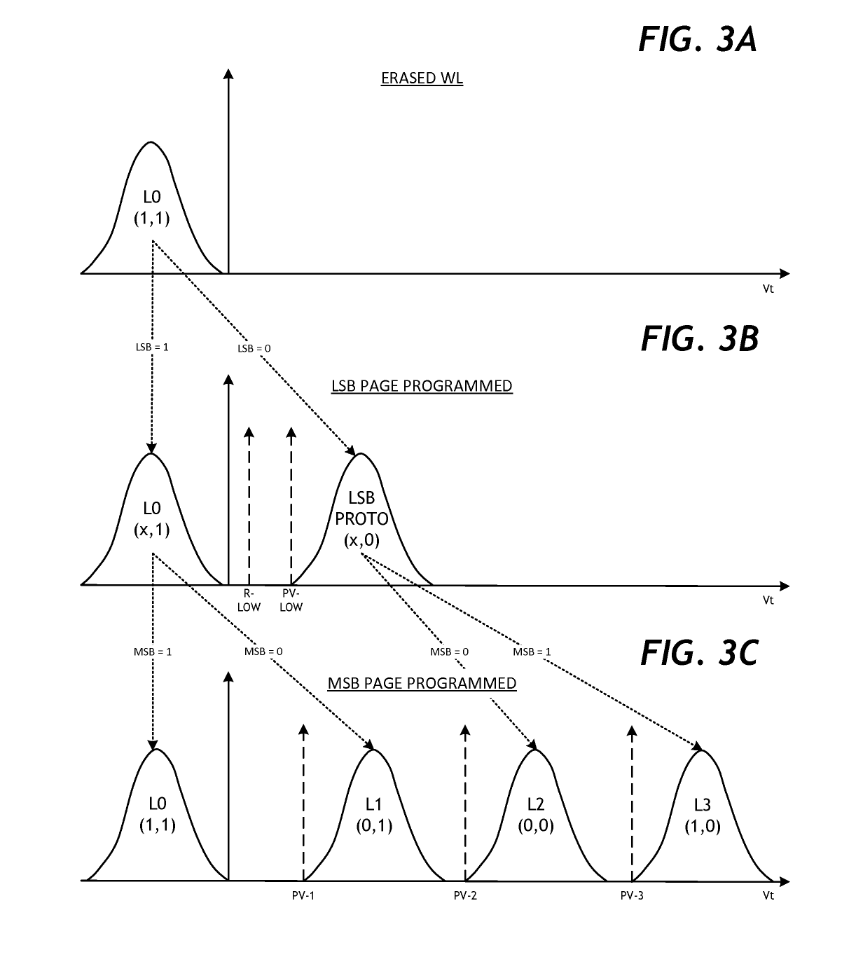

Programming in an MLC programming scheme may be performed in multiple stages. FIGS. 3A-3C illustrate probability distributions of cells at various stages of a programming process according to an embodiment. FIG. 3A illustrates a voltage distribution in which cells of a page of solid-state memory are in a first state, such as an erased state. In certain embodiments, cells are programmed from an erased state. Therefore, prior to programming, it may be necessary or desirable for a page of solid-state memory to be erased to allow for proper programming, as described herein.

In certain embodiments, MLC programming comprises two steps: in a first step, as illustrated in FIG. 3B, an LSB page may be programmed. For example, in an embodiment, for a cell having an LSB value of ‘1,’ the cell may remain substantially in a low-voltage erased state, whereas a cell having an LSB value of ‘0’ may be programmed above a higher program voltage (PV-Low). LSB page programming may be achieved by applying one or more programming pulses to the designated cells to push the programmed cells past PV-Low. Therefore, as illustrated, after LSB programming, the voltage distribution may comprise two separate states, which may be referred to as LSB “proto” states, or pages.

Following LSB programming, the MSB page may be programmed, as illustrated in FIG. 3C. Whereas the LSB page programming may result in division of cells into two proto voltage states (a first state corresponding to a lower level/state, such as an erased state, and a second state corresponding to a higher level/state), MSB programming may further divide the distribution into four states. For example, as states L0 and L1 both may correspond to an LSB value of ‘1,’ in certain embodiments, the lower LSB proto page may be split into the L0 and L1 states, wherein allocation to L0 or L1 is determined by the relevant MSB value. In certain embodiments, where the MSB page is ‘1’ (and LSB is ‘1’), cells may be permitted to remain in a lowest voltage state (e.g., erased state). Furthermore, where the MSB page is ‘0,’ the cells may be programmed past a programming voltage level PV-1. With respect to the cells corresponding to an LSB value of ‘0,’ the MSB programming of such cells may be performed by programming cells having an MSB value of ‘0’ past a programming voltage level PV-2 to a third voltage state L2. Furthermore, cells having an MSB value of ‘1’ may be programmed from the higher LSB proto page past a programming voltage PV-3 to a fourth voltage state L3.

The programming scheme illustrated in FIGS. 3A-3C corresponds to a gray-coding scheme, in which no more than one bit differentiates adjacent voltage states. Although certain embodiments are described herein in the context of the gray-coding voltage scheme of FIGS. 3A-3C, systems and methods disclosed herein may be implemented in other programming schemes as well. Therefore, in certain embodiments, the programming steps shown may be modified to accommodate other schemes, while maintaining the operational principles disclosed herein.

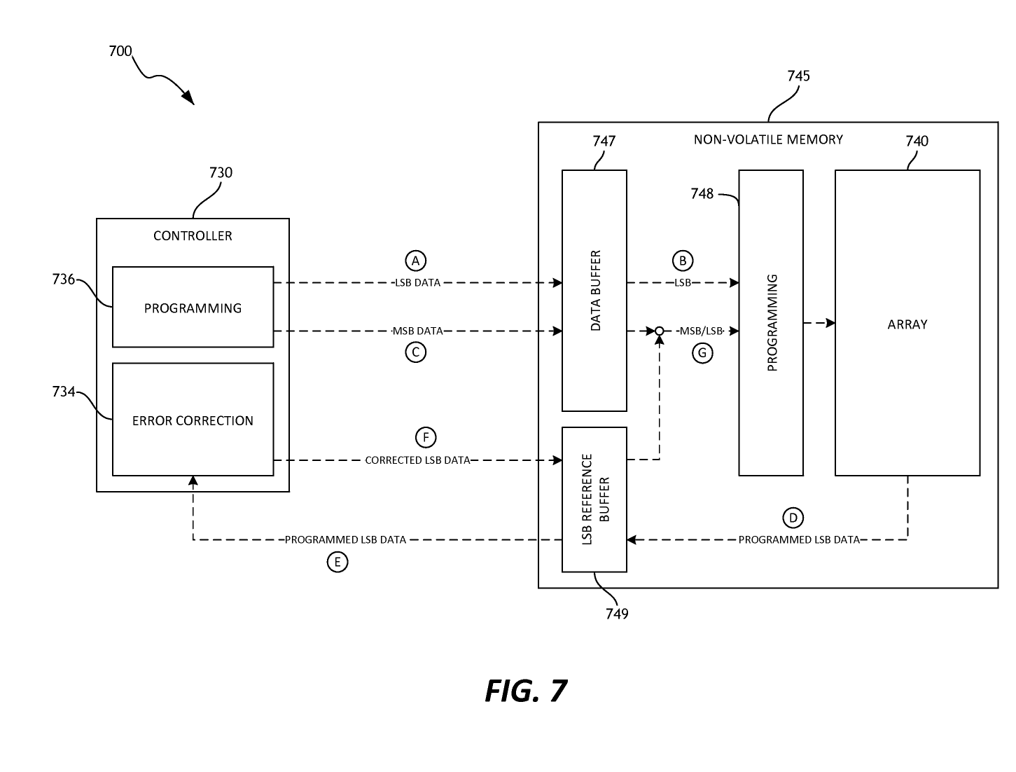

In order to determine how MSB programming is to be implemented on the programmed LSB page, it may be necessary or desirable for the programmed LSB data to be read out from the non-volatile memory array. For example, LSB data may be decoded by reading the LSB proto page at a reference voltage level (R-Low) positioned between the two LSB states. Details associated with the read-out of LSB data are described below in connection with FIG. 7.

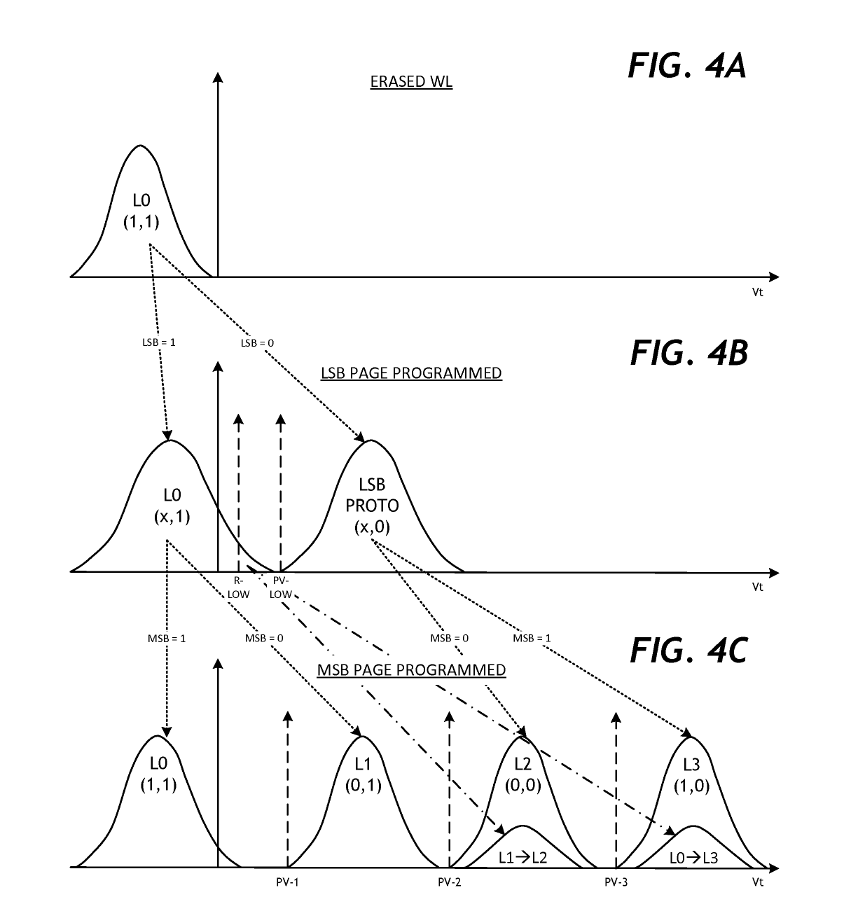

Because the programming of MSB pages can depend on the read-out LSB values, corrupted LSB values can lead to misprogramming of the MSB page. FIGS. 4A-4C illustrate probability distributions of cells at various stages of a programming process resulting in misprogramming according to an embodiment. In particular, MSB misprogramming may occur when a lower LSB proto page (L0 in FIG. 4B) overlaps the LSB read voltage (R-Low). As P/E cycle count increases, the LSB page cell distribution may widen. Furthermore, interference caused by programming of the higher LSB proto page may have a widening effect on the lowest (e.g., erased) LSB proto page. FIG. 4B illustrates a distribution in which the lower LSB proto page has widened enough to overlap the LSB read level R-Low. Therefore, a read of the LSB data may return an incorrect value for those cells that have migrated across R-Low, and may be misinterpreted for purposes of MSB programming.

As shown in FIG. 4C, the overlapping cells may lead to collections of misprogrammed cells around the L2 and L3 states. Such misprogramming can be particularly problematic because error correction may not be able to correct such programming errors, as such errors are at least partially a result of programming itself, as opposed to endurance and/or data retention issues.

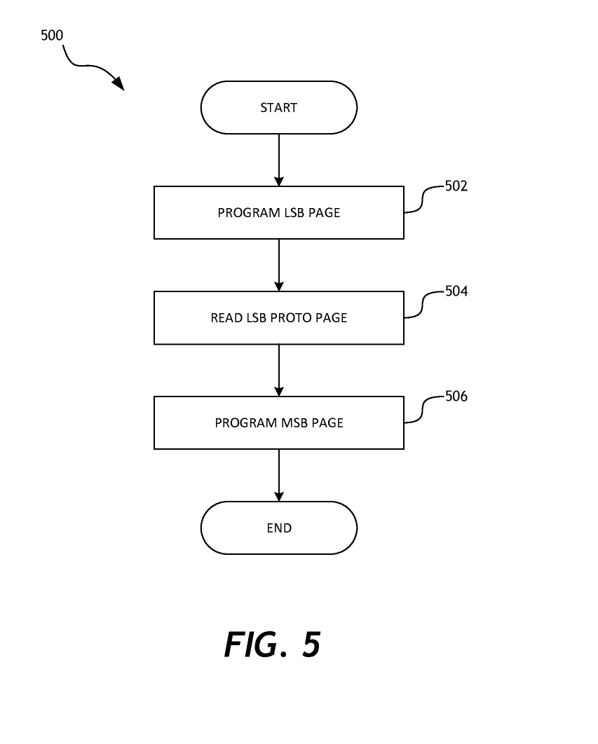

Certain embodiments disclosed herein provide for prevention of misprogramming in an MLC programming scheme based on performance of error correction with respect to programmed LSB data prior to MSB programming. FIG. 5 is a flow diagram illustrating a process 500 for programming data in a non-volatile memory array according to an embodiment. In one embodiment, the process 500 is performed at least partially by the controller 130 and/or error correction module 134. As described above, a process 500 for programming data in a solid-state memory may include first programming an LSB page (502) and subsequently programming an MSB page (506). The programmed LSB page may be read out for the purposes of determining how MSB programming is to be performed.

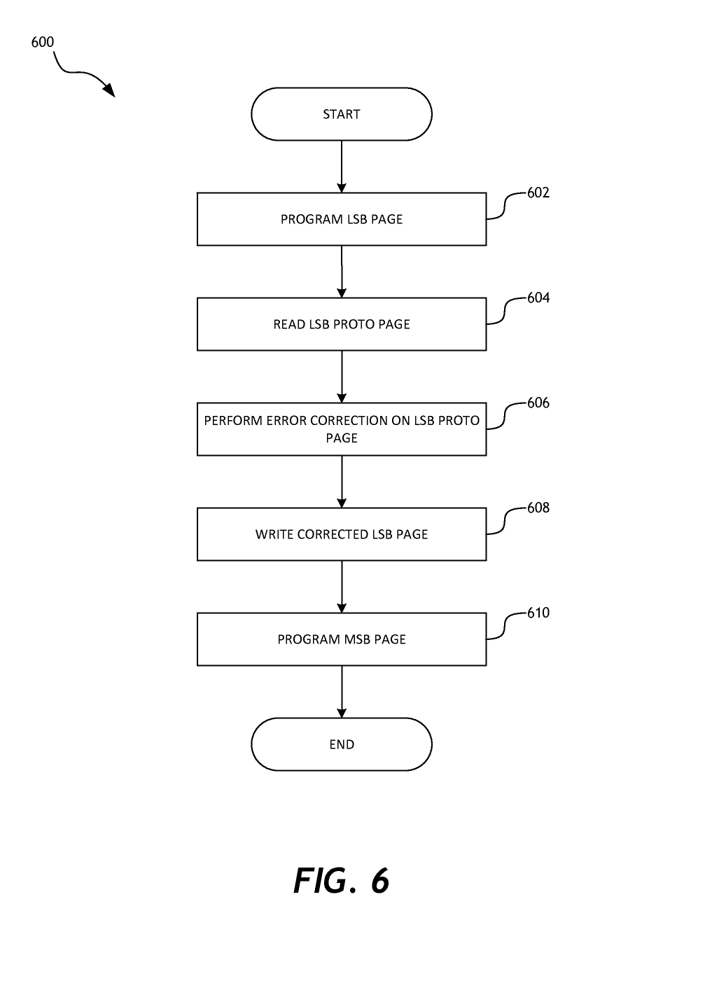

FIG. 6 provides a modified process 600 for programming data in a solid-state memory, wherein error correction is performed on programmed LSB data prior to MSB programming. In one embodiment, the process 600 is performed at least partially by the controller 130 and/or error correction module 134, or the controller 730 and/or error correction module 734 described below in connection with FIG. 7. As shown, LSB page data may be programmed at block 602 and subsequently read out from non-volatile memory at block 604. Prior to programming MSB page data based on the read-out LSB data at block 610, the process 600 includes performing error correction on the read-out LSB page data at block 606. For example, the LSB data may be read out from the non-volatile memory array and provided to an error correction module, wherein the error correction module returns corrected LSB proto page data to the non-volatile memory. Therefore, the non-volatile memory may prevent possible misprogrammings by basing MSB programming on the corrected, as opposed to pre-correction, LSB proto page data.

The process 600 may further include writing corrected LSB data to the non-volatile memory, such as to a reference buffer of the non-volatile memory for use in programming MSB page data. Performing error correction on LSB proto page data as shown in FIG. 6 may at least partially prevent the formation of spurious L2 and L3 distributions caused by misprogramming, as described herein. The process 600 of FIG. 6 may be understood with reference to the diagram of FIG. 7.

FIG. 7 is a block diagram of a data storage system including lower page error correction according to an embodiment. The system 700 includes a controller 730 comprising a programming module 736 configured to execute programming commands in a non-volatile memory 745. The reference identifiers A-G demonstrate a possible sequence of operations for providing misprogramming prevention according to one or more embodiments disclosed herein. However, the various operations and/or functions of the various components of the system 700 may be performed or implemented in any suitable or desirable sequence.

When executing a write command in the non-volatile memory 745, the programming module 736 may be configured to write LSB data associated with the command to the non-volatile memory array. For example, the LSB data may be provided to, or otherwise received by, a data buffer 747 of the non-volatile memory 745. The non-volatile memory 745 may be configured to program the buffered data to a memory array 740 of the non-volatile memory. For example, the LSB data may be provided to programming hardware 748 of the non-volatile memory 745, which may be configured to write the data to the memory array 740. The programming module 736 may further provide MSB data associated with the programming command to the non-volatile memory 745 for programming therein.

In programming the MSB data, the non-volatile memory 745 may be configured to read out the previously-programmed LSB data from the array 740 to a data buffer 749 for reference in programming the MSB data. The buffer 749 may be separate from, or integrated with, the data buffer 747. The non-volatile memory 745 may be configured to use the buffered LSB data in combination with the MSB data from the controller 730 to program the MSB data to the array, as described above.

In certain embodiments, the error correction module may receive from the LSB data buffer 749 the read-out LSB data prior to programming of the MSB data in the array 740. For example, the non-volatile memory 745 may provide the LSB data to the controller 730, or the controller 730 may otherwise receive the LSB data. In certain embodiments, the error correction module 734 performs error correction on the LSB data and provides the corrected data to the non-volatile memory 745. For example, the corrected LSB data may be written to the buffer 749. In certain embodiments, the corrected data overwrites the read-out LSB data in the buffer 749. The non-volatile memory 745 may access the corrected LSB data as a reference for programming the MSB data in the array 740. In an embodiment, the MSB data and the corrected LSB proto page data may be combined and provided to the programming module 748.

The system 700 may provide for improved device performance based on reduced misprogramming errors, which may increase device lifetime and/or drive-writing capability. In certain embodiments, the LSB data error correction functionality described herein is performed by the non-volatile memory 745. For example, the non-volatile memory 745 may include an error correction module for performing LSB proto page error correction internally instead of, or in addition to, external LSB error correction.

### Additional Embodiments

Those skilled in the art will appreciate that in some embodiments, other types of data storage systems and/or programming schemes can be implemented. In addition, the actual steps taken in the processes discussed herein may differ from those described or shown in the figures. Depending on the embodiment, certain of the steps described above may be removed, others may be added. Furthermore, the steps of the various methods described herein may be performed in any suitable or desirable sequence.

While certain embodiments have been described, these embodiments have been presented by way of example only, and are not intended to limit the scope of protection. Indeed, the novel methods and systems described herein may be embodied in a variety of other forms. Furthermore, various omissions, substitutions and changes in the form of the methods and systems described herein may be made. The accompanying claims and their equivalents are intended to cover such forms or modifications as would fall within the scope and spirit of the protection. For example, the various components illustrated in the figures may be implemented as software and/or firmware on a processor, ASIC/FPGA, or dedicated hardware. Also, the features and attributes of the specific embodiments disclosed above may be combined in different ways to form additional embodiments, all of which fall within the scope of the present disclosure. Although the present disclosure provides certain preferred embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims.

What is claimed is:

1. A data storage device comprising:
a non-volatile memory array including a plurality of non-volatile memory cells; and
a controller configured to:
program a first page of a plurality of memory cells of the non-volatile memory array;
submit the programmed first page to an error correction module;
receive correction data relating to the first page from the error correction module; and
program a second page of the plurality of memory cells based at least in part on the correction data.

2. The data storage device of claim 1, wherein the controller is further configured to substantially prevent misprogramming of the second page at least in part by submitting the programmed first page to the error correction module.

3. The data storage device of claim 1, wherein the first page corresponds to a least significant bit of a multi-level cell (MLC) and the second page corresponds to a most significant bit of the MLC.

4. The data storage device of claim 1, wherein the first page corresponds to a least significant bit of a three-level cell (TLC) and the second page corresponds to a most significant bit or a second-most significant bit of the TLC.

5. The data storage device of claim 1, wherein the correction data includes corrected first page data and wherein the controller is further configured to submit the corrected first page data to a data buffer.

6. The data storage device of claim 5, wherein the controller is further configured to program the second page based at least in part on the correction data.

7. The data storage device of claim 1, wherein the controller is further configured to receive the programmed first page from a data buffer.

8. The data storage device of claim 1, wherein the programmed first page of the plurality of memory cells is a least significant bit (LSB) proto page.

9. The data storage device of claim 1, wherein the controller is further configured to submit the programmed first page to the error correction module prior to programming the second page.

10. A method of programming data in a data storage system comprising a non-volatile memory array, the method comprising:
programming a first page of a plurality of memory cells a non-volatile memory array;
submitting the programmed first page to an error correction module;
receiving correction data relating to the first page from the error correction module; and
programming a second page of the plurality of memory cells based at least in part on the correction data;
wherein the method is performed under the control of a controller of the data storage system.

11. The method of claim 10, further comprising substantially preventing misprogramming of the second page by said submitting the programmed first page to the error correction module.

12. The method of claim 10, wherein the first page corresponds to a least significant bit of a multi-level cell (MLC) and the second page corresponds to a most significant bit of the MLC.

13. The method of claim 10, wherein the first page corresponds to a least significant bit of a three-level cell (TLC) and the second page corresponds to a most significant bit or a second-most significant bit of the TLC.

14. The method of claim 10, further comprising submitting the correction data to a data buffer.

15. The method of claim 14, further comprising programming the second page based at least in part on the correction data.

16. The method of claim 10, further comprising receiving the programmed first page from a data buffer.

17. The method of claim 10, wherein the programmed first page of the plurality of memory cells is a least significant bit (LSB) proto page.

18. The method of claim 10, wherein said submitting the programmed first page to the error correction module is performed prior to said programming the second page.
